(19) United States
(12) Patent Application Publication
(10) Pub. No.: US 2025/0069574 A1
(43) Pub. Date: Feb. 27, 2025

(54) ACOUSTIC ABSORPTIVE PANEL

(71) Applicant: Baresque Intelletaul Property Pty Limited, Artarmon (AU)

(72) Inventor: Angus Blaiklock, Artarmon (AU)

(73) Assignee: Baresque Intellectual Property Pty Limited, Artarmon (AU)

(21) Appl. No.: 18/779,485

(22) Filed: Jul. 22, 2024

(30) Foreign Application Priority Data
Aug. 24, 2023 (AU) 2023902711

(51) Int. Cl. G10K 11/168; B32B 3/30; B32B 27/36

(52) U.S. Cl. CPC G10K 11/168; B32B 3/30; B32B 27/36; B32B 2250/02; B32B 2307/102; B32B 2307/7376

(57) ABSTRACT

An acoustic absorptive panel comprises a continuous face layer, a first acoustic absorptive layer located on a rear surface of the face layer, wherein the absorptive layer includes at least one channel having a channel opening terminating at or near an outer edge of the continuous face layer.

### REFERENCE TO RELATED APPLICATION

This application claims the benefit of Australian Patent Application No. 2023902711 filed Aug. 24, 2023, which is hereby incorporated by reference.

### FIELD OF THE INVENTION

The present invention relates to an acoustic absorptive panel. In particular, the present invention relates to an acoustic absorptive panel for indoor use, and in one embodiment as a whiteboard panel. However, it will be appreciated by those skilled in the art that the acoustic absorptive panel may have applications in other fields.

### BACKGROUND OF THE INVENTION

Sound absorption, also referred to as soundproofing or acoustic treatment, plays an important role in both residential and commercial settings due to its significant impact on comfort, productivity, and overall well-being.

In residential spaces, such as houses and apartments, effective sound absorption can help to create a peaceful environment by reducing external noises like traffic, construction, and noise from nearby premises. By minimising the transmission of sound between rooms and floors, sound absorption improves privacy and minimises disturbances.

In commercial settings, such as offices, restaurants, shops and public spaces, sound absorption plays an important role in enhancing productivity and improving communication. Unwanted noise, generated from conversations, equipment, or echoing footfall, can lead to distractions, decreased focus, and increased stress levels among employees or customers.

Effective sound absorption solutions mitigate these issues by creating a quieter and more controlled environment, enabling employees or customers to concentrate without disruption. Moreover, in spaces like restaurants and entertainment venues, adequate sound absorption contributes to a pleasant customer experience by improving speech intelligibility, reducing echo, and preventing excessive noise from affecting the overall ambiance.

Certain soft finishes such as fabrics, textiles and carpet may assist with noise reduction when used correctly. In contrast, hard surfaces such as masonry, timber, concrete and other hard claddings which are commonly used in walls, partitions, floors, and ceilings tend to reflect sounds, and provide minimal sound absorption.

Traditionally hard acoustic absorptive surfaces require perforations. Such materials typically include timber or metal manufactured with a matrix of holes formed on the face surface and mounted to an acoustic backing material. However, such acoustic materials have a specific aesthetic which may not be desirable in some settings. Furthermore, there are limited facing materials suitable for use in such acoustic panels.

The aforementioned hard surfaced acoustic materials may suffer from drawbacks such as being difficult to clean, easily damaged, and may not be suitable for certain locations due to risk of infection or microbial contamination, on account of the surface perforations.

Accordingly, the durability and ease of cleaning hard acoustic materials can be problematic, especially in commercial settings where there may be considerable wear and tear over time.

Any reference herein to known prior art does not, unless the contrary indication appears, constitute an admission that such prior art is commonly known by those skilled in the art to which the invention relates, at the priority date of this application.

### SUMMARY OF THE INVENTION

In a first aspect, the present invention provides an acoustic absorptive panel comprising:
a continuous face layer,
a first acoustic absorptive layer located on a rear surface of the face layer,
wherein the absorptive layer includes at least one channel having a channel opening terminating at or near an outer edge of the continuous face layer.

The acoustic absorptive panel further preferably comprises a second acoustic absorptive layer located between the continuous face layer and the first acoustic absorptive layer.

The second acoustic absorptive layer is preferably continuous.

The continuous face layer defines a hard surface preferably formed from one of: laminate;
whiteboard;
timber;
MDF;
plywood;
plasterboard;
compressed fibre cement;
metal;
glass; or wallcovering, ceramic, polymer.

The continuous face layer preferably defines a flexible material formed from one of laminate or a wallcovering.

The first acoustic dampening layer is preferably formed from PET acoustic backing.

The channel preferably has a body portion which is larger in cross-sectional area than the channel opening.

The channel body is preferably elongated having an open proximal end opening onto the channel opening and an enclosed distal end.

The open proximal end is preferably rounded.

The enclosed distal end is preferably rounded.

The acoustic absorptive panel preferably comprises a plurality of said channels.

Each of the channels preferably extends generally parallel with each other.

The panel preferably defines the writing surface of a wall mounted or free-standing whiteboard.

In a second aspect, the present invention provides a method of forming an acoustic absorptive panel, the method including the steps of:
forming at least one channel in a first acoustic absorptive layer, the channel having at least one channel opening terminating at or near an outer edge of the first acoustic absorptive layer, and
locating the first acoustic absorptive layer on a rear surface of a continuous face layer.

The method preferably includes the step of placing a second acoustic absorptive layer between the continuous face layer and the first acoustic absorptive layer.

### BRIEF DESCRIPTION OF THE DRAWINGS

FIG. 1 is a front view showing an acoustic absorptive panel according to the invention;

FIG. 2 is a front perspective view showing the acoustic absorptive panel of FIG. 1 and mounting battens;

FIG. 3 is a rear perspective view showing the acoustic absorptive panel of FIG. 1; and

FIG. 4 is a partial perspective rear view showing a lateral edge of the absorptive layers of the acoustic absorptive panel of FIG. 1.

### DETAILED DESCRIPTION OF PREFERRED EMBODIMENTS

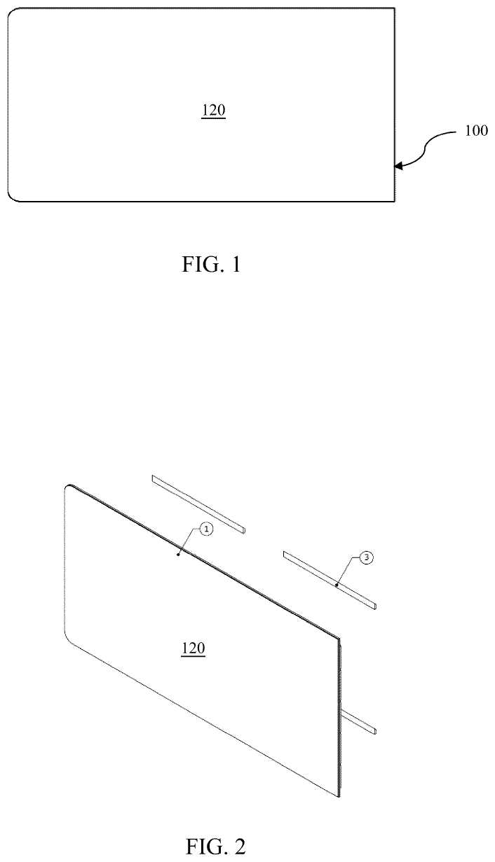

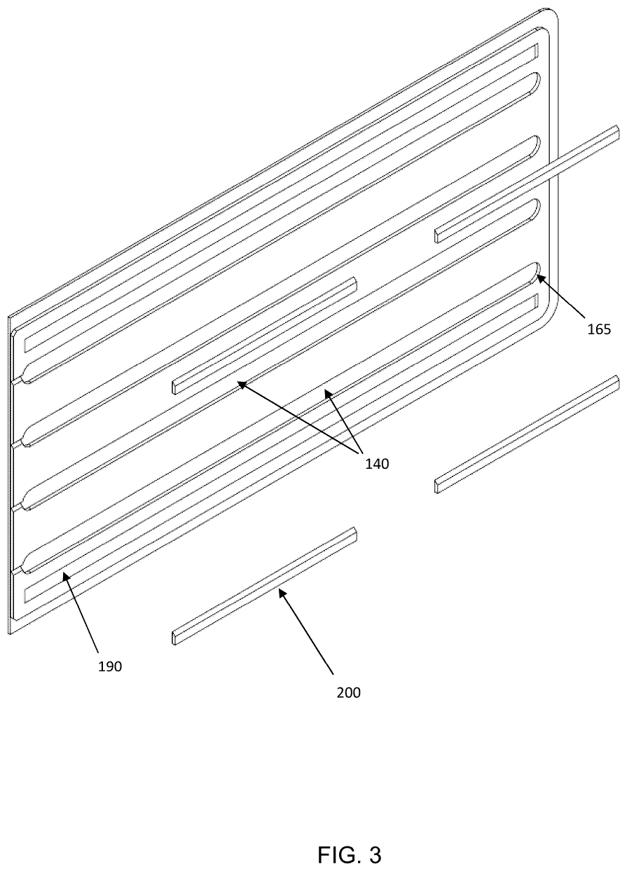

FIG. 1 shows an acoustic absorptive panel 100 in accordance with the invention, depicted from the front or user facing side. The acoustic absorptive panel 100 can be used in both indoor and outdoor applications, and particularly indoors as a wall, partition, or ceiling cladding in residential and commercial settings.

In one embodiment, the acoustic absorptive panel 100 is provided in the form of a whiteboard, having a smooth front surface for writing on. The white board may be wall mounted, or alternatively free standing for securement to a frame or a mobile structure. However, it will be appreciated that the acoustic absorptive panel 100 can be used in any setting where acoustic absorption is desired in respect of a hard panel surface.

The acoustic absorptive panel 100 has a continuous face layer 120, which is free of any openings or apertures. For example, the continuous face layer 120 can be formed from a hard material including, but not limited to, one of laminate, MDF, acrylic, whiteboard, timber, plywood, plasterboard, compressed fibre cement, glass or various polymers. Alternatively, the continuous face layer 120 may be defined by a flexible material, for example one that can be supplied in roll form, such as laminate, wallcoverings etc.

The face layer 120 provides an aesthetic and hardwearing functional layer.

In the preferred embodiment, the face layer 120 is continuous, having no holes or breaks on its front (room facing) surface. However, it will be appreciated that the face layer 120 could alternatively be provided having surface texturing in the form of a pattern or image applied thereto. The face layer 120 may be provided having an outer perimeter detail to enable adjacent panels to mate or nest together, such as corresponding male and female engagement formations.

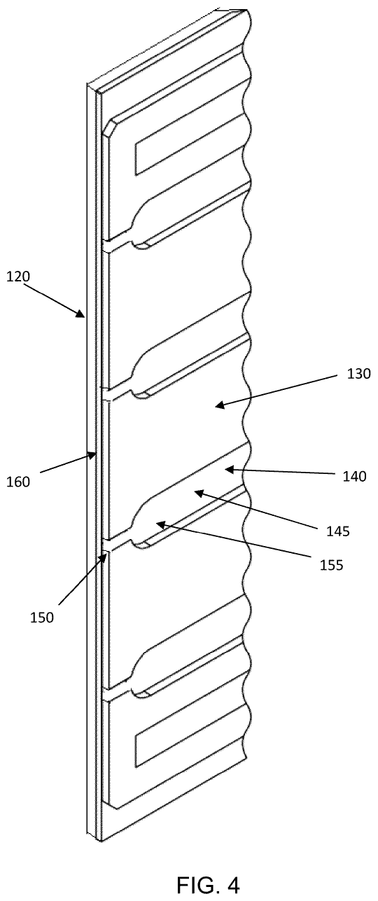

As depicted in FIG. 4, a first acoustic absorptive layer 130 is located on a rear surface of the face layer 120. The first acoustic absorptive layer 130 includes at least one channel 140 having a channel opening 150 terminating at or near an outer edge of the continuous face layer 120.

The acoustic absorptive panel 100 further comprises a second acoustic absorptive layer 160 which is located between the continuous face layer 120 and the first acoustic absorptive layer 130. In this preferred embodiment, the acoustic absorptive panel 100 is defined by a sandwich of three layers, namely the face layer 120, the first acoustic absorptive layer 130, and an intermediate second acoustic absorptive layer 160.

In the preferred embodiment, the first acoustic absorptive layer 130, and the second acoustic absorptive layer 160 are formed from the same or similar materials.

The thickness of each of the two absorptive layers may be in the range of 6 mm to 24 mm. In one embodiment, each of the two absorptive layers is either 12 or 24 mm in thickness.

In one embodiment, the first acoustic absorptive layer 130 and the second acoustic absorptive layer 160 are fabricated from acoustic polyethylene terephthalate (PET) into a polymer felt. However, it will be appreciated that other acoustic materials which provide favourable nose reduction characteristics may alternatively be used. One specific material which is suitable for the first acoustic absorptive layer 130 and the second acoustic absorptive layer 160 is a polyester felt sold under the brand ZINTRA™.

The second acoustic absorptive layer 160 is continuous, having no holes or perforations.

The front, face layer 120 provides an aesthetic or hardwearing functional layer. The rearmost first acoustic absorptive layer 130 is a PET layer with channels 140 that allow the sound to travel from a perimeter of the area behind the hard face layer 120 to then become trapped. The intermediate second acoustic absorptive layer 160 is a PET layer which assists with trapping the sound in the channels 140.

In one embodiment, the dimensions of the channel 140 are approximately 100 mm wide and between 400 mm and 2700 mm in length.

The three layers consisting of the continuous face layer 120, the first acoustic absorptive layer 130 and the second acoustic absorptive layer 160 are secured to each other with adhesive and/or or mechanically fixed together with fasteners, such as staples, screws, nails, or bolts.

In one embodiment, the first acoustic absorptive layer 130 and the second acoustic absorptive layer 160 may be integrally formed and defined by a single, monolithic layer of acoustic material, with the channels 140 defined by a removed portion of the volume, but not extending through the full thickness of the combined first acoustic absorptive layer 130 and second acoustic absorptive layer 160. For example, the channels 140 may be routed, cut or moulded or otherwise recessed to partially remove some, for example around 50%, of the thickness of the single monolithic layer.

Referring to FIGS. 3 and 4, the channels 140 each have a channel opening 150 terminating at or near an outer edge of the continuous face layer 120. The channels 140 each have a body portion 145 which is larger in cross-sectional area than the channel opening 150. In a preferred embodiment, the channel openings 150 are rectangular in cross-section.

As shown in FIGS. 3 and 4, the channel body portion 145 is elongated having an open proximal end 155 opening onto the channel opening 150 and an enclosed distal end 165. The open proximal end 155 is rounded and the enclosed distal end 165 is also similarly rounded.

Referring to FIG. 3, the acoustic absorptive panel 100 comprises a plurality of the channels 140. In the embodiment depicted, there are four channels 140. However, it will be appreciated that there may be one, two, three or more than four channels 140.

In the preferred embodiment, the channels 140 each extend generally parallel with each other.

In another embodiment (not shown) the channels 140 may be interconnected with secondary channels or other such noise dissipation and absorption passages.

In one embodiment, the channels 140 extend to and intersect the edge on either the short or long side of the panel 100. As such, the channels 140 may extend to either the horizontal or vertical edges of the panel 100.

In an alternative arrangement, the channels 140 extend to and intersect edges on both the short and long side of the panel 100. As such, in this embodiment, the channels 140 may extend to both the horizontal and vertical edges of the panel 100.

A method of forming the acoustic absorptive panel 100 includes the steps of forming at least one channel 140 in a first acoustic absorptive layer 130, the channel 140 having at least one channel opening 150 terminating at or near an outer edge of the first acoustic absorptive layer 120. The method also includes the step of locating the first acoustic dampening layer on a rear surface of the continuous face layer 120.

The channel 140 can be formed by cutting or may be manufactured in the intended shape, for example by moulding.

The method further including the step of placing a second acoustic absorptive layer 160 between the continuous face layer 120 and the first acoustic absorptive layer 130. The second acoustic absorptive layer 160 and the first acoustic dampening layer 130 may be integrally formed or separately formed and subsequently attached.

The second acoustic absorptive layer 160 assists with trapping sound in the channels 140. The rearmost first acoustic absorptive layer 130, which includes the channels 140, allows sound to travel from a perimeter region of the continuous face layer 120, and the sound is trapped and absorbed in the channels 140.

In the embodiment shown in the rear view of FIG. 3, the rearmost first acoustic absorptive layer 130 is provided with mounting slots 190 which are sized to receive corresponding mounting battens 200. This arrangement provides a male and female engagement formation to secure the acoustic absorptive panel 100 to an underlying support surface, such as an existing wall or ceiling. The mounting battens 200 and mounting slots 190 can be secured with adhesive, fasteners or by interference fit. It will be appreciated that alternative mounting arrangements may be employed. For example, the panels 100 could be glued or screwed or hung on the wall with other hardware.

Advantageously, the face layer 120 is easy to clean on account of the continuous, hard surface and due to the lack of any apertures which are commonly required in hard acoustic panels.

The channels 140 allow the sound to travel from the perimeter to the area behind the hard surface of the face layer 120.

### EXAMPLES

The following are two non-limiting examples of the acoustic absorptive panel 100.

### First Example

In the first example, there are two laminated absorptive layers, with the first (rearmost) layer 130 including the channels 140, which are formed through the full thickness of the first layer 130. The first layer 130 and the second layer 130 are secured with adhesive to each other, and to the face layer 120.

| Component | Material | thickness |
|---|---|---|
| continuous face layer 120 | Dry-erasable or dry | Approximately |
| | erasable/magnetic | 0.5 mm |
| | surface | |
| first (rear) acoustic absorptive | PET-polyethylene | 12 mm |
| layer 130 | terephthalate | |
| second (intermediate) acoustic | PET-polyethylene | 12 mm |
| absorptive layer 160 | terephthalate | |

### Second Example

In the second example, there is a single monolithic absorptive rear layer, and the channels 140, are recessed into only a portion of the thickness of the first layer 130, for example 12 mm deep. The first layer 130 is secured with adhesive to the face layer 120

| Component | Material | thickness |
|---|---|---|
| continuous face layer 120 | High Pressure Laminate | Approximately 1 mm |
| first (rear) acoustic | PET-polyethylene | 25 mm full thickness, |
| absorptive | terephthalate | with channels formed |
| layer 130 | | about 12 mm |
| | | deep in rear surface. |

Advantageously, PET provides structural integrity, lightness of weight, acoustic absorption, and ease of fabrication. However, other acoustic materials may alternatively be used.

Wherever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

1. An acoustic absorptive panel comprising:
a continuous face layer,
a first acoustic absorptive layer located on a rear surface of the face layer,
wherein the absorptive layer includes at least one channel having a channel opening terminating at or near an outer edge of the continuous face layer.

2. The acoustic absorptive panel of claim 1, further comprising a second acoustic absorptive layer located between the continuous face layer and the first acoustic absorptive layer.

3. The acoustic absorptive panel of claim 2, wherein the second acoustic absorptive layer is continuous.

4. The acoustic absorptive panel of claim 1, wherein the continuous face layer defines a hard surface formed from one of:
laminate;
whiteboard;
timber;
MDF;
plywood;
plasterboard;
compressed fibre cement;
metal;
glass; or wallcovering, ceramic,
polymer.

5. The acoustic absorptive panel of claim 1, wherein the continuous face layer defines a flexible material formed from one of: laminate or a wallcovering.

6. The acoustic absorptive panel of claim 1, wherein the first acoustic dampening layer is formed from PET acoustic backing.

7. The acoustic absorptive panel of claim 1, wherein the channel has a body portion which is larger in cross-sectional area than the channel opening.

8. The acoustic absorptive panel of claim 1, wherein the channel body is elongated having an open proximal end opening onto the channel opening and an enclosed distal end.

9. The acoustic absorptive panel of claim 8 wherein the open proximal end is rounded.

10. The acoustic absorptive panel of claim 9, wherein the enclosed distal end is rounded.

11. The acoustic absorptive panel of claim 1, comprising a plurality of said channels.

12. The acoustic absorptive panel of claim 11, wherein each of the channels extends generally parallel with each other.

13. The acoustic absorptive panel of claim 1, wherein the panel defines the writing surface of a wall mounted or free-standing whiteboard.

14. A method of forming an acoustic absorptive panel, the method including the steps of:
forming at least one channel in a first acoustic absorptive layer, the channel having at least one channel opening terminating at or near an outer edge of the first acoustic absorptive layer, and
locating the first acoustic absorptive layer on a rear surface of a continuous face layer.

15. The method of claim 14, further including the step of placing a second acoustic absorptive layer between the continuous face layer and the first acoustic absorptive layer.
